(19) United States
(12) Patent Application Publication
(10) Pub. No.: US 2016/0211793 A1
(43) Pub. Date: Jul. 21, 2016

(54) SLAT ROOF

(71) Applicant: Jürgen GRIMMEISEN, Stuttgart (DE)

(72) Inventor: Jürgen GRIMMEISEN, Stuttgart (DE)

(21) Appl. No.: 14/915,543

(22) PCT Filed: Jun. 30, 2014
(86) PCT No.: PCT/EP2014/063829

§ 371 Date: Feb. 29, 2016

(30) Foreign Application Priority Data
Aug. 29, 2013 (DE) 10 2013 109 391.4

(51) Int. Cl. H02S 20/30; H02S 20/26; E04B 7/16; H02S 20/23; E04D 13/03; E04D 13/035

(52) U.S. Cl. CPC H02S 20/30; E04D 13/0325; E04D 13/0351; E04B 7/163; H02S 20/23; H02S 20/26

(57) ABSTRACT

A slat roof with slats and with an adjusting device for rotating the slats about a rotational axis between a closed and an open rotational position, the rotational axis running parallel to the longitudinal extension of the slats. In the closed rotational position, the slats lie against one another in overlap regions along the longitudinal edges of the slats and/or are coupled to one another by sealing elements or guiding systems which engage into one another, and the slats can be adjusted into rotational positions up to the completely open rotational position by the adjusting device. Solar cells for converting solar energy into electric energy and/or a solar collector for converting solar energy into thermal energy are attached in or on at least one of the slats or are integral components of the slats. This invention allows the incident light into a roofed area to be regulated while simultaneously using the impinging solar energy.

### BACKGROUND OF THE INVENTION

1. Field of the Invention

This invention relates to a slat roof having slats, and having an adjusting device for rotating the slats, about a rotation axis running parallel to a longitudinal extent thereof, between a closed and an open rotation position, wherein the slats, when in the closed rotation position, lie against one another along their longitudinal edges in overlap regions and/or are assigned to one another by sealing elements or mutually engaging guide systems, and wherein the slats can be adjusted into rotation positions, up to the fully open rotation position, by the adjusting device.

2. Discussion of Related Art

A slat roof is taught by European Patent Reference EP 1 127 992 B1. The document describes a slat roof having a plurality of parallel slats that, on their transverse sides, are each mounted on fixed lateral parts so as to be pivotable, about an axis that is parallel to the longitudinal extent of the slats, between an open position and a closed position, wherein, when in a closed position, the front edge of each slat covers the rear edge of the preceding slat.

Such a slat roof, when in the closed state, provides protection against weather and sun. The sealing elements and the mutually engaging guide systems prevent rain from penetrating the slat roof. The slat roof can be opened by rotating the slats, such that sunlight can enter the space beneath. The light incidence can be regulated by an appropriate selection of the rotation position of the slats. Warm air can be removed through the openings of the slat roof, thus avoiding a build-up of heat. Slat roofs are therefore suitable, preferably, for covering terraces and balconies, but also for covering enclosed spaces, for example winter gardens, arbors, pergolas, carports, etc.

It is disadvantageous in this case that the incident solar radiation is absorbed by the slats, and consequently the roof and the space underneath it become heated, and that the incident solar radiation is reflected back without being utilized.

German Patent Reference DE 10 2005 047 624 A1 teaches a windproof sun shade, having a multiplicity of slats that are fastened with mutual spacing to a mounting and form a shadow on the underside that faces away from the sun. In this case, the slats are rotatably or flexibly mounted on the mounting by their upper edges that face toward the sun, and hang down freely due to gravity. According to represented embodiments of the invention, the slats may be realized as photovoltaic elements for producing electricity from sunlight, or as heat transfer elements, having a liquid heat transfer medium, for producing hot water. The arrangement thus does not offer weather protection in the form of a roof, but only protection against sun. In this case, the slats are positioned by gravity and the available wind, and cannot be adjusted in their position in relation to the sun. The predominantly downward alignment of the slats is unfavorable for the utilization of solar energy, and the arrangement of the slats also prevents effective utilization of the solar energy, because of their mutual shading.

### SUMMARY OF THE INVENTION

It is one object of this invention to provide a weatherproof slat roof for effective utilization of the incident solar energy.

The above object and others of this invention are achieved if solar cells, for converting solar energy into electrical energy, and/or a solar collector, for converting solar energy into thermal energy, are attached in or to at least one of the slats or are integral components of the slat. The solar energy that is incident upon the slat roof can thus be converted into electrical energy by the solar cells, or into thermal energy, for example for the provision of hot water, by the solar collector. The solar roof is preferably oriented in a southward direction, such that the sun radiates onto the surface area of the roof over a long daytime period. For example, a south-facing terrace can be roofed-over in a weatherproof manner and the roof opened when required, such that sunlight falls onto the terrace with an intensity that can be regulated. When in a closed position, the solar cells or the solar collectors are oriented toward the sun in an appropriate non-shaded manner, in order to achieve a high efficiency. However, in the open position, also, most of the solar radiation reaches the solar cells or solar collectors, such that the solar energy can be utilized in this slat position also. A further advantage of this invention includes that some of the irradiated solar energy is utilized for producing electricity or hot water, and therefore does not contribute to heating of the slat roof or of the roof-covered space.

In order for the sunlight to reach the solar cells or the solar collectors, it is possible for the slat to have, at least regionally, on the top side that faces toward the outside of the slat roof when in the closed position, at least one transparent cover, under which the solar cells and/or the solar collector are disposed, and/or that the slat has respectively at least one transparent cover, at least regionally, on both top sides. The transparent cover in this case is part of the outer sheath of the slat, and provides a smooth, robust and easily cleaned surface that protects the solar cells and solar collectors underneath against mechanical stresses, for example caused by hail.

Advantageously, the transparent cover may be made from a transparent plastic or from glass, in particular from a laminated safety glass or a tempered glass. Transparent plastic offers one advantage of low weight. Glass results in a significant stiffening of the slats, thereby increasing the capacity of the slat roof to bear loading, for example by snow. Use of a tempered glass or laminated safety glass enables compliance with the relevant standards for overhead glazing. Glass offers the further advantage of a hard, scratch-free surface.

Optical losses on the transparent cover may be reduced if the transparent cover is provided, on one or both sides, with an anti-reflective coating and/or with a structuring having an anti-reflective effect and/or with a dirt-repellent coating and/or with a dirt-repellent structuring and/or with a coating that reflects infrared radiation.

With a glass cover, in the case of perpendicular incidence approximately 4% of the incident solar radiation is reflected on each top side of the glass cover, and is thus lost with regard to energy production. This reflected proportion can be reduced by an appropriate anti-reflective coating or structuring, and the efficiency of energy production can thus be improved. It then proves particularly advantageous that, in the case of oblique light incidence, as may frequently be expected in the case of a slat roof, depending on the rotation position of the slats, the proportion of the reflected radiation, and consequently the possible energy yield, are increased significantly by a corresponding anti-reflective coating or structuring.

The soiling of the slat roof depends greatly on its installation site and, in unfavorable conditions, may result in the transmission of the transparent cover, and consequently the efficiency of the energy production, being reduced by over 15%. A dirt-repellent coating or structuring (lotus effect) can at least reduce the soiling, and have a positive effect upon the efficiency.

For solar collectors in particular, the use of an IR-reflecting coating of the transparent cover is advantageous. Such an IR-reflecting layer may be realized as a transparent layer, in the visible wavelength range. The sunlight, in the wavelength range of which is the radiation maximum of the sun, can then reach the solar collector unimpeded, and heat the latter and the heat transfer medium flowing in the solar collector. The thermal radiation emitted by the solar collector dependent on its temperature is reflected back to the solar collector by the IR-reflecting coating, such that energy losses due to thermal radiation can be significantly reduced. Owing to the comparatively low temperature of the solar collector, the emitted radiation is long-wave radiation, such that, with an appropriately selected IR-reflecting coating, the reflective band can be placed such that most of the solar radiation can pass unimpeded through the coating and the transparent cover, while the long-wave radiation emitted by the solar collector is reflected. The IR-reflecting coating in this case may be applied on the outside of the transparent cover or, protected against mechanical damage, on the inside.

The slat roof can be made sufficiently stable, even in the case of large roof spans, if the slat is of or composed of respectively one main body made of metal, preferably of aluminum, or of plastic, and that the transparent cover is indirectly or directly applied to the main body.

A tight, durable and, at the same time, easily produced connection between the main body and the transparent cover can be achieved if the transparent cover is connected to the main body by a full-perimeter adhesive bond.

A slat generating electrical current can be realized with a simple structure if solar cells, as thin-film solar cells, are applied directly onto the transparent cover, or, as crystalline solar cells, are connected to the transparent cover by a lamination process, and that the transparent cover, in a structural unit with at least the solar cells and electrical connections connected to the solar cells, constitutes or forms a photovoltaic module. Such a photovoltaic module, produced according to known production methods, can be mounted, as a structural unit, onto the main body of the slat. Since, with this arrangement, the solar cells are arranged close to the surface of the slat, shading by the main body can be avoided.

According to an alternative design variant of this invention, it is possible for one or more photovoltaic modules to be arranged, as separate structural units, in the main body of the slat. In this case, the photovoltaic modules are located within the slat, protected by the main body and the transparent cover. It is advantageous in this case that the photovoltaic modules do not have to be produced as long, narrow strips, corresponding to the extent of a slat, but that a plurality of shorter photovoltaic modules can be arranged in a slat. Such shorter photovoltaic modules can be produced on existing production lines, the use of a plurality of photovoltaic modules per slat making it possible to achieve a correspondingly high density of solar cells on the slat roof.

A simple and inexpensive solar collector can be obtained in that, for the purpose of forming the solar collector on the main body, absorber channels, for the passage of a liquid heat transfer medium, are formed-on in an integral manner. The solar collector then does not have to be provided as a separate structural unit, but can be produced, inexpensively, directly with the main body.

According to one embodiment of this invention, a solar collector, having an absorber tube, which runs parallel to the longitudinal extent of the slat, for the passage of a liquid heat transfer medium, and having absorber faces formed integrally on the absorber tube, is disposed in the slat The solar collector in this case may be placed in the main body of the slat such that there is only a slight thermal contact between the solar collector and the main body. As a result, the thermal conduction from the solar collector to the surroundings can be reduced, and the efficiency of the latter can be increased correspondingly. The absorber faces enable the solar radiation that is incident upon the slat to be absorbed over a large area.

The efficiency of the solar collector may be further increased if the absorber tube and/or the absorber faces formed onto the absorber tube are coated with a selective absorber layer having a high absorption for solar radiation and having a low emission for thermal radiation, and/or that at least regions of the main body provided with absorber channels are coated with such a selective absorber layer. The selective absorber layer increases the absorption of sunlight and, at the same time, reduces the emission of the long-wave thermal radiation that is dependent on the temperature of the absorber.

Highest efficiencies can be achieved if one or more vacuum-tube collectors are disposed in the slat. Such vacuum-tube collectors may be obtained as standard components and arranged in the slats. Vacuum-tube collectors are composed of an absorber tube, in which the liquid heat transfer medium is routed, and of a glass tube encompassing the absorber tube. The cavity between the absorber tube and the glass tube is evacuated, thereby minimizing the thermal losses of the collector.

An efficiency improvement principle comparable to the vacuum-tube collectors may be used if the cavity of the slat that is encompassed by the main body and the cover is sealed in a vacuum-tight manner, and if the air pressure in the cavity is reduced relative to the ambient pressure, and/or that the cavity is filled with an inert gas. The thermal conduction to the environment from a solar collector disposed in the slat can be significantly reduced as a result, which has a positive effect on the efficiency of the solar collector. Argon or krypton, for example, may be used as inert gases.

A solar collector may be easily connected to the heat transfer medium circuit if the rotation axis of the slat runs in the center of the absorber tube or in the center of a vacuum-tube collector. With this arrangement, advantageously, the center of gravity of the slat is located in, or at least close to, the rotation axis, enabling the slats of the slat roof to be easily rotated with a small expenditure of force. This is particularly relevant in the case of large slat roofs, in which a multiplicity of slats, provided with solar collectors, are moved simultaneously.

The slat that can be rotated about the rotation axis can be connected to the rigid line network of the heat transfer medium circuit if the heat transfer medium is supplied to and removed from the solar collector via a respective tube connection that can be rotated about its longitudinal axis and in the rotation axis of the slat. Such a tube connection, which in itself is rotating, enables a rigid tube of the line network of the heat transfer medium circuit to be connected in a tight manner to a rotatable tube of the solar collector.

According to one embodiment of this invention, it is possible for an adjusting device to be provided, at least on one side of the slat, and for the adjusting device to comprise a tilt lever and a linkage that is movably connected to the tilt lever via a pivot joint, if the tilt lever is rotatably mounted in the rotation axis of the slat and rigidly connected to the main body of the slat and/or to a connecting tube leading from one of the rotatable tube connections to the solar collector, and if the tilt lever, the slat and the connecting tube can be rotated about the rotation axis of the slat by a linear movement of the linkage. The adjusting device enables the slats to be opened and closed. For this purpose, the linear movement of the linkage may be effected by a crank handle or an electric drive. The tilt lever may be realized so that the rotation axis of the slat is outside of the slat. This enables the slat to be swiveled fully out of the plane of the roof, about the rotation axis. If such an adjusting device is provided on both sides of the slats, a high stability of the slat roof when in the open position can be achieved.

In order to ensure reliable runoff of rainwater, the roof plane of the slat roof can be perpendicular to the rotation axis of the slats and have an incline, or that the roof plane perpendicular to the rotation axis of the slats is oriented with an incline horizontally and parallel in relation to the rotation axis of the slats, and the individual slats, when in their closed position, have an incline perpendicular to their rotation axis.

It is possible for an adequate self-cleaning of the slat roof to be achieved if the incline of the roof plane or of the individual slats perpendicular to their rotation axes is greater than 10°, preferably greater than 15°.

High efficiency in the conversion of solar energy to useful energy, as well as a high degree of adjustability of the solar radiation that is let through, can be enabled if the slat roof is mounted in an orientation facing toward the course of the sun and that, in the case of opening of the slats, the sides of the slats that face toward the course of the sun are rotated upward out of the roof plane.

In some embodiments of this invention, the slats can be rotated beyond the fully open rotation position, preferably the slats, starting from the closed position, can be rotated up to an angle of approximately 180°. Since the slats can be rotated further, beyond the fully open position, it is possible to achieve better adjustment of the insolation into the shaded region beneath the slat roof. Advantageously in this case, slats provided with a transparent cover on both sides can be used, disposed behind which there are, for example, absorbers, oriented to both sides, for the inserted solar collectors, or bifacial solar cells that convert light, incident on both sides of the solar cells, into electricity.

### BRIEF DESCRIPTION OF THE DRAWINGS

This invention is explained in greater detail in the following exemplary embodiments represented in the drawings, wherein:

FIG. 1 shows a slat roof as a roof covering of a terrace;

FIG. 2 shows a detail of a slat roof in a closed rotation position;

FIG. 3 shows a detail of a slat roof in an open rotation position;

FIG. 4 shows a slat having a photovoltaic module; and

FIG. 5 shows a slat having a combination of a photovoltaic module and a solar collector.

### DETAILED DESCRIPTION OF THE INVENTION

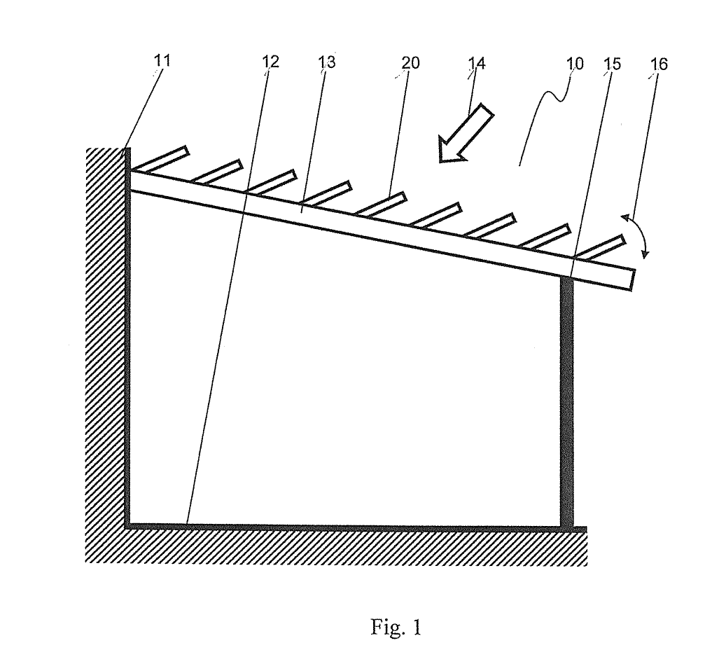

FIG. 1 shows a slat roof 10 as a roof covering of a terrace 12. Slats 20, which are rotatable about their longitudinal extent or length, are held in a frame profile 13 that, on one side, is mounted on a house wall 11 and, on the opposite side, is supported on support posts 15. The possible rotational movement 16 of the slats 20 is indicated by a double arrow. The slat roof 10 is oriented southward, so that solar radiation 14 is incident upon the slat roof 10.

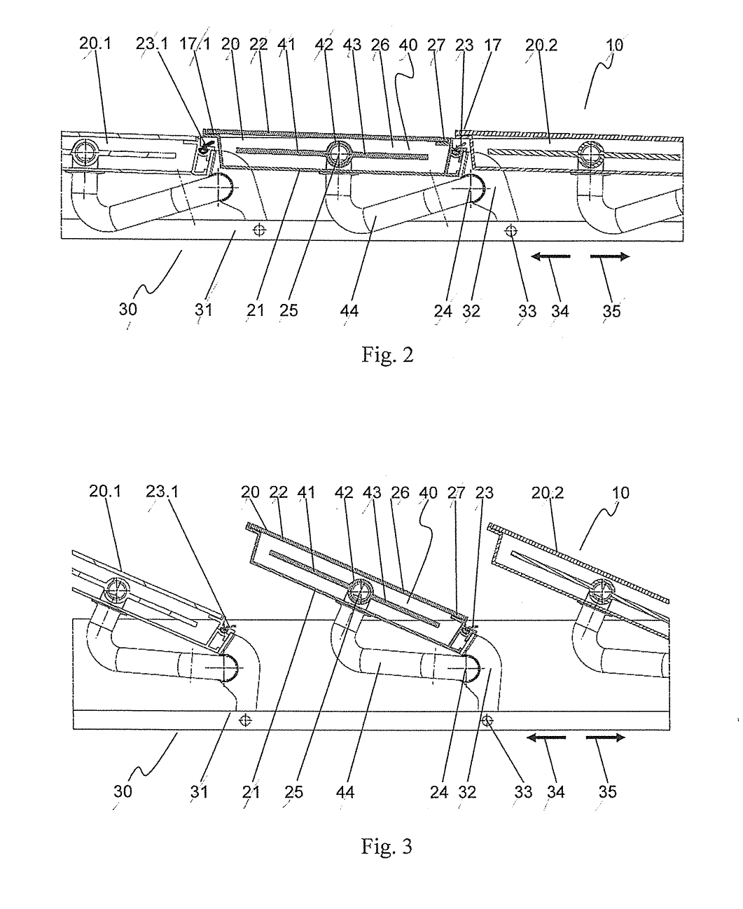

By means of or with an adjusting device 30, shown in FIG. 2, the slats 20 can be rotated, about a rotation axis 24 running parallel to their longitudinal extent or length and likewise shown in FIG. 2, between a closed position and any open rotation position. When in the closed position, the slats 20 overlap and form a watertight roof covering. The solar radiation 14 that is incident upon the terrace 12 can be regulated by opening of the slats 20 and selection of an appropriate rotation position.

Advantageously, the slat roof 10 has an incline of at least 15°, in order to support self-cleaning by the runoff of rainwater. Alternatively, the individual slats may have a transverse incline of, for example, 15° in relation to each other. The rainwater can then be routed to the left and right in the longitudinal direction of the slats 20, toward rain gutters. In the case of this embodiment, the slat roof 10 can span the terrace 12 horizontally.

FIG. 2 shows a detail of a slat roof 10 in a closed rotation position, in a sectional representation. Three slats 20, 20.1, 20.2 of identical design are shown, and the description that follows therefore relates to the middle slat 20.

The slat 20 is constructed from a main body 21 and a transparent cover 22. The slats 20, 20.1, 20.2 lie against one another along their long sides in overlap regions 17, 17.1, the transition being sealed by a respective sealing element 23, 23.1. The transparent cover 22 is connected to the main body 21 in a water-tight manner by a full-perimeter adhesive bond 27. A solar collector 40, comprising an absorber tube 42 and two absorber faces 41, 43 formed integrally onto the absorber tube 42, is disposed in a cavity 26 of the slat 20 that is formed by the main body 21 and the transparent cover 22. The absorber tube 42 is connected to a connecting tube 44 of angular shape. A tilt lever 32 is rigidly connected to the connecting tube 44 and to the main body 21 of the slat 20. The tilt lever 32, in turn, is mounted on a linkage 31 via a pivot joint 33, and together with the latter constitutes or forms an adjusting device 30 for the slat 20. The linkage 31 can be moved linearly, according to the represented movement directions 34, 35. A rotation axis 24 of the slat 20 runs outside of the slat 20, parallel to the longitudinal extent thereof.

The solar collector 40 is for thermal utilization of the solar energy. Via the transparent cover 22, solar radiation 14 that is incident upon the slat roof 10 reaches the solar collector 40, where it is absorbed by the absorber tube 42 and the absorber faces 41, 43. A liquid heat transfer medium, which is supplied to the absorber tube 42 via the connecting tube 44, becomes heated as a result. The service water or heating water that is to be heated may be provided directly as a heat transfer medium, or a closed primary circuit may be provided, from which the heat transfer medium delivers its energy, in a heat exchanger, not represented, to the service water or heating water flowing in a secondary circuit.

In the exemplary embodiment shown, the cavity 26 of the slat 20 is filled with an inert gas at reduced pressure, in order to avoid energy losses due to thermal conduction and convection. The transparent cover 22 is made of a tempered glass (toughened safety glass), in order to ensure a sufficient stability, for example in the case of high loading of the slat roof 10 by snow. In order to improve the efficiency of the energy production, the transparent cover 22 is provided, on both sides, with a coating that has an anti-reflective effect, such that reflection losses at the glass surfaces are reduced and a higher proportion of the incident solar radiation 14 reaches the solar collector 40. The absorber tube 42 and the absorber faces 41, 43 are coated with a selective absorber layer, having a high degree of absorption in the wavelength range of the solar radiation 13 and having a low degree of emission in the wavelength range that is dependent on the temperature of the solar collector 40. The solar radiation 14 is thus absorbed to the best possible extent, while the emission of thermal radiation by the solar collector 40 is reduced, this having a positive effect on the efficiency.

For opening the slat roof 10, the linkage 31 of the adjusting device 30 is moved linearly along the first movement direction 34. This causes the tilt lever 32 to be rotated about the rotation axis 24, by the pivot joint 33. The slat 20, which is connected to the tilt lever 32, and the connecting tube 44 are thereby also rotated about the rotation axis 24, and the slat 20 is swiveled out of the roof plane.

The heat transfer medium is supplied to the connecting tube 44 via a tube connection, not represented, that is rotatable in the rotation axis 24 of the slat 20. For this purpose, the tube connection is disposed in the rotation axis 24 of the slat 20, and enables the connecting tube 44 to be connected in a tight manner to the rigid line network, likewise not represented, of the heat transfer medium. On the opposite side of the slat 20, the heat transfer medium is returned to the line network of the heat transfer medium through a comparable connecting tube and a corresponding tube connection.

In a further embodiment of this invention, an alternative rotation axis 25 may be provided, which runs in the center of the absorber tube 42. The adjusting device 30 in this case is to be adapted such that the slats 20 can be rotated about this alternative rotation axis 25. In the case of this embodiment variant, it is possible to dispense with the connecting tube 44, and the heat transfer medium can be fed directly into the absorber tube 42 via a rotatable tube connection.

FIG. 3 shows a detail of the slat roof 10 in an open rotation position of the slats 20, 20.1, 20.2. The same references as those introduced in relation to FIG. 2 have been used.

As compared with the closed rotation position shown in FIG. 2, the linkage 31 of the adjusting device 30 has been shifted linearly along the first movement direction 34. As a result, the tilt lever 32 and, correspondingly, the slat 20 connected to the tilt lever 32, and the connecting tube 44 have been rotated about the rotation axis 24 of the slat 20. In the same way, the second slat 20.1 and the third slat 20.2 have been rotated out of the plane of the slat roof 10, such that openings form between the slats 20, 20.1, 20.2, through which sunlight can enter the space roofed-over by the slat roof 10. The incidence of light into the roof-covered space can be regulated by the selection of the tilt angle of the slats 20, 20.1, 20.2.

In the exemplary embodiment shown, the main body 21 is made of aluminum, and the transparent cover 22 is made of tempered glass. Alternatively, the main body 21 may also be made of another metal or of plastic, while a transparent plastic may be used for the transparent cover 22. Furthermore, a getter may be introduced into the cavity 26 of the slat 20, in order to bind penetrating gas molecules and thus maintain an existing vacuum in the slat 20.

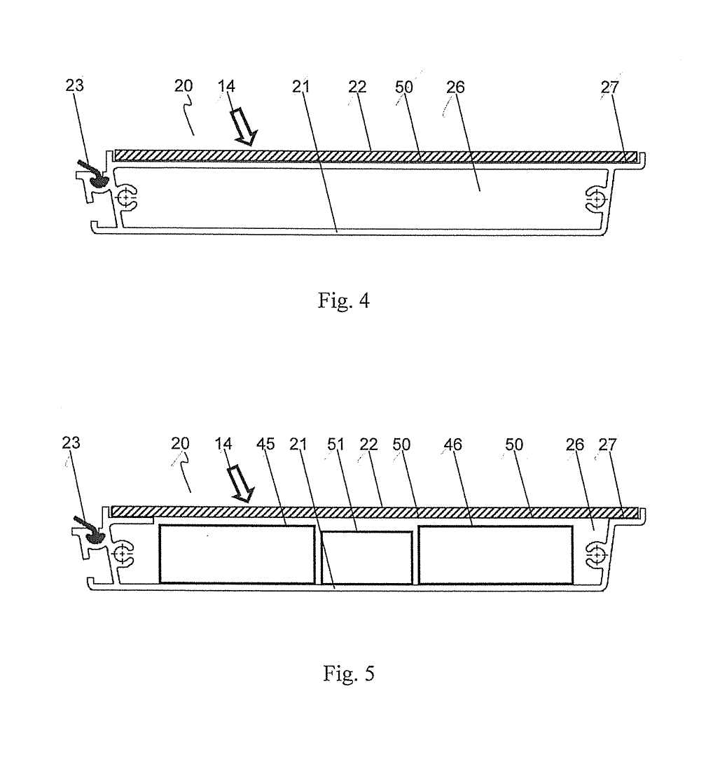

FIG. 4 shows a slat 20 having a photovoltaic module 50. The photovoltaic module 50 exists as a structural unit, comprising the transparent cover 22, the solar cells, which are not shown in the scaled representation because of their thinness, an insulation on the back and electrical connections. The photovoltaic module 50 is attached to the main body 21 by a full-perimeter adhesive bond 27. The solar radiation 14 is directly incident upon the top side of the slat 20.

The solar cells are applied directly, as thin-film solar cells in their layer structure, to the transparent cover 22. In the present exemplary embodiment, CIGS cells (CuInGaSe₂) having a correspondingly high efficiency are used, but any other types of thin-film cell may be used. Alternatively, the photovoltaic module may be constructed with crystalline solar cells that are connected to the transparent cover 22 by a lamination process.

The photovoltaic module 50 extends over the entire length of the slat 20. Alternatively, a plurality of shorter photovoltaic modules 50 may be thus disposed along the top side of the slat 20. Shorter photovoltaic modules 50 offer the advantage that they can be produced in existing production lines for photovoltaic modules 50 in which the maximum length of the photovoltaic modules 50 is limited.

In the case of the structure shown, it is advantageous that the photovoltaic module 50 is attached directly to the top side of the slat 20, where a maximum insolation without shading, for example by the main body 21, may be assumed.

FIG. 5 shows a slat 20 having a combination of a photovoltaic module 50 and a solar collector 40.

The slat 20, as already described, is constructed from a main body 21 surrounding a cavity 26, a transparent cover 22 and a sealing element 23.

The photovoltaic module 50 is realized as a partially transparent thin-film module. In the case of such a partially transparent thin-film module, a portion of the incident solar radiation 14 penetrates into the cavity 26 of the slat 20 underneath. The electrical connections of the photovoltaic module are brought together in a junction box 51 that is integrally formed onto the main body 21.

The solar collector 40 comprises or is composed of two absorber channels 45, 46, which are likewise integrally formed onto the main body 21, and through which the heat transfer medium flows.

The slat 20 thus renders possible both the production of electricity by the photovoltaic module 50 and the provision of hot water by the solar collector 40. Inexpensive production is possible if the absorber channels 45, 46 and the junction box 51 are formed integrally. In order to improve the efficiency, the surface of the transparent cover 22 is provided with a coating that has an anti-reflective effect, and the absorber channels 45, 46 are provided with a selective absorber layer.

In an alternative embodiment, the photovoltaic module 50 and the junction box 51 may be omitted, and the slat 20 designed solely for the thermal utilization of the solar energy. A greater proportion of the incident solar radiation 14 is thus delivered to the solar collector 40. Since the absorber channels 45, 46 are integrally formed-on, a slat 20 having a solar collector 40 can be constructed very inexpensively. In this case, the absorber channels 45, 46 serve as additional stiffening for the slat 20.

In the embodiment of this invention as shown, all slats 20 of the slat roof 10 are controlled equally, and accordingly have the same orientation. Alternatively, it may be provided that individual slat groups may be controlled and oriented separately. This makes it possible, for example, to open one part of the slat roof 10 while another part of the slat roof 10 remains closed.

In a further embodiment of this invention, individual slats 20 or groups of slats 20 may be transparent and realized without solar cells or solar collectors. This is possible, for example, if there are transparent covers 22 provided on both top sides of the slats 20. Such transparent slats 20 allow light to enter the roof-covered space even when the slat roof 10 is in a closed position.

According to a further embodiment of this invention, some of the slats 20 of a slat roof 10 are provided with solar collectors 40 and some with solar cells. Such a slat roof 10 allows both the thermal utilization of the solar energy and the production of electricity.

1. A slat roof (10) having slats (20), and having an adjusting device (30) for rotating the slats (20), about a rotation axis (24) running parallel to a longitudinal extent thereof, between a closed rotation position and an open rotation position, wherein the slats (20), when in the closed rotation position, lie against one another along longitudinal edges in overlap regions (17, 17.1) and/or are assigned to one another by sealing elements (23, 23.1) or mutually engaging guide systems, and wherein the slats (20) can be adjusted into rotation positions, up to a fully open rotation position, by the adjusting device (30), the slat roof (10) comprising solar cells converting solar energy into electrical energy and/or a solar collector (40) converting solar energy into thermal energy, attached in or to at least one of the slats (20) or integral components of the slat (20).

2. The slat roof (10) according to claim 1, wherein the slat (20) has, at least regionally, on a top side facing toward an outside of the slat roof (10) when in the closed position, at least one transparent cover (22) under which the solar cells and/or the solar collector (40) are disposed, and/or the slat (20) has respectively at least one transparent cover (22), at least regionally, on both top sides.

3. The slat roof (10) according to claim 1, wherein the transparent cover (22) is made from a transparent plastic or from glass, in particular from a laminated safety glass or a tempered glass.

4. The slat roof (10) according to claim 1, wherein the transparent cover (22) is provided on one or both sides with an anti-reflective coating and/or with a structuring having an anti-reflective effect and/or with a dirt-repellent coating and/or with a dirt-repellent structuring and/or with a coating that reflects infrared radiation.

5. The slat roof (10) according to claim 1, wherein the slat (20) is of respectively one main body (21) made of metal, preferably of aluminum, or of plastic, and the transparent cover (22) is indirectly or directly applied to the main body (21), and/or the transparent cover (22) is connected to the main body (21) by a full-perimeter adhesive bond (27).

6. The slat roof (10) according to claim 1, wherein solar cells, as thin-film solar cells, are applied directly onto the transparent cover (22), or as crystalline solar cells, are connected to the transparent cover (22) by a lamination process, and the transparent cover (22), in a structural unit with at least the solar cells and electrical connections connected to the solar cells, forms a photovoltaic module (50).

7. The slat roof (10) according to claim 1, wherein one or more photovoltaic modules (50) are arranged, as separate structural units, in the main body (21) of the slat (20).

8. The slat roof (10) according to claim 1, wherein for the purpose of forming the solar collector (40) on the main body (21), absorber channels (45, 46), for the passage of a liquid heat transfer medium, are formed-on in an integral manner.

9. The slat roof (10) according to claim 1, wherein a solar collector (40), having an absorber tube (42), which runs parallel to the longitudinal extent of the slat (20), for the passage of a liquid heat transfer medium, and having absorber faces (41, 43) formed integrally on the absorber tube (42), is disposed in the slat (20).

10. The slat roof (10) according to claim 1, wherein an absorber tube (42) and/or absorber faces (41, 43) formed onto the absorber tube (42) are coated with a selective absorber layer having a high absorption for solar radiation and having a low emission for thermal radiation, and/or at least regions of the main body (21) provided with absorber channels (45, 46) are coated with such a the selective absorber layer.

11. The slat roof (10) according to claim 1, wherein one or more vacuum-tube collectors are disposed in the slat (20).

12. The slat roof (10) according to claim 1, wherein the cavity (44) of the slat (20) is encompassed by the main body (21) and the cover (22) is sealed in a vacuum-tight manner, and the air pressure in the cavity (44) is reduced relative to the ambient pressure, and/or the cavity (44) is filled with an inert gas.

13. The slat roof (10) according to claim 1, wherein the rotation axis of the slat (20) runs in a center of the absorber tube (42) or in a center of a vacuum-tube collector.

14. The slat roof (10) according to claim 1, wherein the heat transfer medium is supplied to and removed from the solar collector (40) via a respective tube connection that can be rotated about a longitudinal axis and in the rotation axis of the slat (20).

15. The slat roof (10) according to claim 1, wherein an adjusting device (30) is provided, at least on one side of the slat (20), the adjusting device (30) comprises a tilt lever (32) and a linkage (31) is movably connected to the tilt lever (32) via a pivot joint (33), the tilt lever (32) is rotatably mounted in the rotation axis (24) of the slat (20) and rigidly connected to the main body (21) of the slat (20) and/or to a connecting tube (44) leading from one of the rotatable tube connections to the solar collector (40), and the tilt lever (32), the slat (20) and the connecting tube (44) are rotatable about the rotation axis (24) of the slat (20) by a linear movement of the linkage (31).

16. The slat roof (10) according to claim 1, wherein a roof plane of the slat roof (10) perpendicular to the rotation axis (24) of the slats (20) has an incline, or the roof plane perpendicular to the rotation axis (24) of the slats (20) is oriented with an incline horizontally and parallelwise in relation to the rotation axis (24) of the slats (20), and the individual slats (20), when in the closed position, have an incline perpendicular to their the rotation axis (24).

17. The slat roof (10) according to claim 1, wherein an incline of the roof plane or of the individual slats (20) perpendicular to the rotation axes (24) is greater than 10°, preferably greater than 15°.

18. The slat roof (10) according to claim 1, wherein the slat roof (10) is mounted in an orientation facing toward a course of the sun and in the case of opening of the slats (20) the sides of the slats (20) that face toward the course of the sun are rotated upward out of the roof plane.

19. The slat roof (10) according to claim 1, wherein the slats (20) can be rotated beyond the fully open rotation position, and the slats (20), starting from the closed position, are rotatable up to an angle of approximately 180°.

20. A slat (20) for the slat roof (10) according to claim 1.
